(19) United States
(12) Patent Application Publication
(10) Pub. No.: US 2004/0242165 A1
(43) Pub. Date: Dec. 2, 2004

(54) RF signal switch for a wireless communication device

(76) Inventor: Pieter Willem Jedeloo, Nijmegen (NL)

Correspondence Address: Aaron Waxler, US Philips Corporation, Intellectual Property Department, P O Box 3001, Briarcliff Manor, NY, 10510, US

(21) Appl. No.: 10/489,646

(22) PCT Filed: Sep. 13, 2002
(86) PCT No.: PCT/IB02/03794

(30) Foreign Application Priority Data
Sep. 18, 2001 (EP) 01203528.3

(51) Int. Cl. H04B 1/38

(52) U.S. Cl. 455/78; 455/73

(57) ABSTRACT

A RF signal switch circuit device in particular for cellular communication applications, comprises an I/O terminal (8) for the received/transmitted signal, respectively, a Tx input terminal (10) connected to I/O terminal (8) through a diode (12) and to a signal source for the signal to be transmitted, a Rx output terminal (18) connected to the I/O terminal (8), and a resonator circuit for isolating the Tx input terminal (10) from the Rx output terminal (18). The resonator circuit is a parallel inductance-capacitance-circuit. The inductor (22) of the resonator circuit is connected between the Tx input terminal (10) and the Rx output terminal (18) and through a diode to ground (24), and the capacitor (20) of the resonator circuit is connected between the I/O terminal (8) and a node (28) between the inductor (22) and ground.

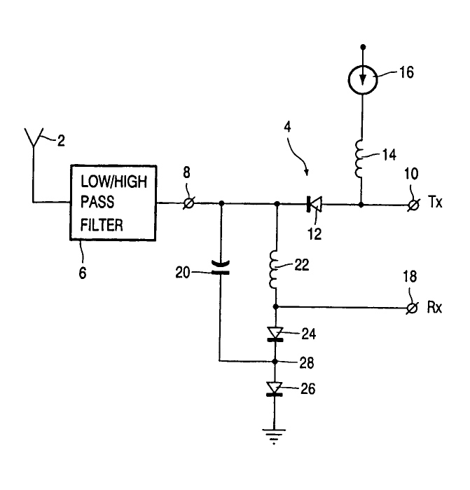

The invention relates to a RF signal switch circuit device and a wireless communication device for wireless communication applications, in particular a RF signal switch circuit device for cellular wireless communication applications and a wireless communication device for cellular applications.

RF power modules for GSM/DCS/PCS cellular communication have a transmit/receive switch function and are provided at the front end of the communication system.

From JP 6139701 A, a hybrid integrated signal switch circuit is known which comprises an I/O terminal for the received/transmitted signal, a Tx input terminal, a Rx output terminal, Tx and Rx being connected to the I/O terminal, and a resonator for isolating Tx from Rx. To reduce the deterioration in isolation between the terminals Tx an Rx and to reduce insertion loss, a part of a main line of a strip line is cut off, and an electrode equipotential is added to a sub line between the edge resulting from the cut and opposed main lines on the main line axis, connecting a semiconductor active element placed on the electrode to both ends of the main line with a metallic wire. In this known circuit, integration is the objective since now the circuits connected to Tx and Rx are separated by the main line of the system.

DE 3506817 A 1 refers to a transmitter-receiver circuit for communication purposes, the isolation means of this circuit having a comparatively low insertion loss. An inductor is provided between the antenna and ground, and a coupling capacitor is provided between the antenna and a high ohmic Rx input. In the transmitting mode, a diode which is controlled so as to be in the conductive state, short-circuits the Rx input. The diode is arranged between the Rx input and a blocking capacitor connected to ground. Concurrently, a second diode connects the coupling capacitor and the inductor to a parallel resonator circuit. In the transmitting mode, the shunt diode must provide full receiver isolation because the λ/4-line is replaced by a single capacitor. Such a circuit arrangement is not designed for GSM and higher frequency applications. As the receiver isolation is insufficient, the current consumption is too high because the series connection of the diodes is replaced by a parallel connection.

It is the object of the invention to provide a RF signal switch circuit device for wireless communication applications and a wireless communication device which allows a better passive integration of the RF signal switch circuit and maintains sufficient functionality in providing low insertion loss and high isolation for a passive integrated receive-transmit circuit.

The object is achieved in a RF signal switch circuit device comprising an I/O terminal for the received/transmitted signal, respectively, a Tx input terminal coupled to the I/O terminal through a diode and to a signal source for the signal to be transmitted, a Rx output terminal coupled to the I/O terminal, and a resonator circuit for isolating the Tx input terminal from the Rx output terminal, said resonator circuit being a parallel inductance-capacitance circuit comprising an inductor and a capacitor.

The circuit device in accordance with the invention advantageously enables a low insertion loss and a high isolation to be obtained for a passive integrated receive-transmit switch circuit. The advantages of a low insertion loss and a high isolation additionally facilitate the fabrication of the circuit as a RF power module. This will also reduce the cost of manufacturing the devices. A further advantage of the circuit of the invention is that there is no trade-off situation between insertion loss and isolation as it is the case with a λ/4 resonator in accordance with the state of the art. Therefore, the required isolation of the Rx channel can be readily obtained. Also miniaturization of the RF front-end power amplifier circuit is proposed due to the improved integration possibilities of the passive components of the circuit as compared to the situation with conventional Tx/Rx switch circuits.

The above object is, furthermore, achieved by a wireless communication device for wireless communication applications, comprising an antenna coupled to a high- and low pass filter, a RF signal switch circuit, a RF receiver and a RF transmitter, said RF signal switch being coupled to said high- and low pass filter by an I/O terminal, to said receiver by a Rx output terminal, and to said transmitter circuit by a Tx input terminal (I/O), wherein

a) said I/O terminal is arranged for receiving and transmitting a RF signal via said high-and low pass filter from respectively to said antenna,

b) said Tx input terminal is coupled to I/O terminal through a diode,

c) said Rx output terminal is coupled to I/O terminal, and

d) said RF signal switch circuit further comprises a resonator circuit for isolating the Tx input terminal from the Rx output terminal said resonator circuit being a parallel inductance-capacitance circuit comprising an inductor and a capacitor.

According to a preferred embodiment of the invention, the inductor is coupled between the Tx input terminal and the Rx output terminal and through a diode to ground, and wherein the capacitor is coupled between the I/O terminal and a node between the inductor and ground. In this arrangement, the capacitive element of the circuit is floating in the off-state (Rx mode) while the small inductance in the inductive element ensures low insertion losses. In the on-state (Tx mode) the resonator greatly improves the isolation of the Rx channel and does fulfill the isolation requirements for this channel.

According to a further preferred embodiment of the invention, the parallel inductance-capacitance circuit is tunable. By using a tunable resonator circuit instead of a fixed λ/4-resonator, it is possible to obtain higher isolation while maintaining a low insertion loss.

According to a further preferred embodiment of the invention, the parallel inductance-capacitance circuit is switchable between pre-selected resonance values. This circuit has the same advantages as the circuit mentioned above that comprises a tunable resonator circuit and, additionally, makes it possible to have preselected resonance values that have been found to be advantageous for the operation of the circuit.

According to a further preferred embodiment of the invention, the inductance-capacitance circuit is dimensioned so as to provide an impedance that is at least 20 times the impedance of the inductor. The possibility of designing the resonator circuit such that the impedance is at least twenty times the impedance of the inductor alone provides for the required isolation between Rx and Tx while said resonator circuit can be easily integrated into the module.

According to a further preferred embodiment of the invention, the components of the circuit are embodied in LTCC technology. Using LTCC (low temperature co-fired ceramic) multilayer technology, it is possible to increase the integration level of the power amplifier switch circuit to an extremely high degree and subsequently integrate front-end functionality.

According to a further preferred embodiment of the invention, the circuit comprises a matched 50 Ohm circuit which promotes the trend towards small matched units.

According to a further preferred embodiment of the invention, the diodes are PIN diodes providing for improved integration and functionality.

For a further understanding of the nature and advantages of the embodiment of the present invention, reference is made to the remaining portions of the specification and the attached drawing.

The circuit in the figure comprises an antenna 2 which is connected to the switch circuit 4 by means of a low- and high pass filter 6. The switch circuit 4 has an I/O terminal 8 for receiving a RF signal from the antenna 2 and transmitting a RF signal to the antenna 2 respectively. A Tx input terminal 10 is connected to the I/O terminal 8 through a diode 12 and to a signal input for the signal to be transmitted, for instance a RF amplifier. The Tx input terminal 10 is further connected through an impedance 14 to a DC source 16. A Rx output terminal 18 is coupled to the I/O terminal 8 and to a RF receiver.

A resonator circuit comprising a tunable capacitor 20 and an inductor 22 and a diode 24 is provided where the inductor 22 and the diode 24 are connected in series. The series arrangement of the inductor 22 and the diode 24 is connected in parallel with the capacitor 20. The inductor 22 is also connected between the Tx input terminal 10 and the Rx output terminal 18 and through the diode 24 to ground. The inductor 22 is, more specifically, connected to the Tx input terminal 10 through diode 12 which provides insulation of the Tx input terminal 10 in the transmit mode.

Finally, a diode 26 is provided between the resonator circuit and ground, more specifically between node 28 and ground. The diodes in the above circuit are PIN diodes.

RF power modules for GSM, DCS, and PCS cellular communication have evolved into smaller matched 50 Ohm units. A logical step in the evolution of PA (Power Amplifier)-modules is the passive integration of RF functions, which will further reduce the overall solution cost of manufacturers of for instance cellular phones or other wireless communication devices. Using a known LTCC multilayer technology, it is possible to increase the integration level of the PA-module to an extreme high degree and subsequently integrate front-end functionality.

The RF design of a front-end PA module typically uses a low- and high pass filter topology with in-circuit discrete current controlled PIN diodes. A conventional RF switch circuit comprises a first PIN diode connected with its anode to the output of a RF transmitter and its cathode via the low- and high pass filter to the RF antenna. The conventional RF switch circuit further comprises a quarter wave length resonator with two terminals of which one is connected via the low- and high pass filter to the RF antenna and the other terminal is connected to both the input of a RF receiver and the anode of a second PIN diode which by its cathode is connected to ground.

Passive integration of the known RF switch circuit is difficult, since a trade-off has to be made between the isolation between the RF transmitter and the RF receiver provided by the quarter wave length resonator and the insertion losses the quarter wave length resonator introduces. Due to this trade-off it is difficult to meet the specification of the Rx channel as required by above mentioned standards. By utilizing the tunable or switchable parallel LC resonator instead of a quarter wave length resonator it is possible to achieve a higher isolation while maintaining low insertion losses in a passive integrated RF switch circuit.

The RF switch circuit according to the invention comprising three PIN diodes 12, 24, 26 and the inductor 22 shunted by the capacitor 20 has a low impedance in the receive mode and presents a high impedance in the transmit mode. In the receive mode capacitor 22 is floating, since the PIN diodes 12, 24, 26 are non-conductive. The transmitter is isolated from the antenna 2 by PIN diode 12. The small inductor 22, which may be formed by for instance a bond wire, fulfills the low insertion loss requirement. In the transmit mode the conducting state of the PIN diodes 12, 24, 26, the parallel LC resonator comprising capacitor 20, inductor 22, and diode 24 enhances the inductor impedance approximately 20 times providing the isolation requirement of the receive channel.

The low- and high pass filter 6 between the switch circuit and the antenna 2 is required in multi-band PA modules to satisfy the overall front-end isolation requirements.

An advantage of a wireless communication device, as for instance a cellular phone, comprising the RF switch circuit according to the invention is that it has smaller dimensions, because the RF switch circuit is realized by means of a passive integrated circuit. A further advantage of a wireless communication device comprising the RF switch circuit according to the invention is that it has a lower cost price, since the passive integrated RF switch circuit is cheaper and easier to handle during production than a conventional RF switch circuit built-up of discrete components.

It will be understood that the above description is intended to be illustrative and not restrictive. Many embodiments will be apparent to those skilled in the art upon reviewing the above description. The scope of the invention should, therefore, be determined not with reference to the above description, but with reference to the appended claims along with the full scope of equivalence to which said claims are entitled.

1. A RF signal switch circuit device for wireless communication applications, comprising:
a) an I/O terminal (8) for the received/transmitted signal, respectively
b) a Tx input terminal (10) coupled to I/O terminal (8) through a diode (12) and to a signal source for the signal to be transmitted,
c) a Rx output terminal (18) coupled to the I/O terminal (8), and
d) a resonator circuit for isolating the Tx input terminal (10) from the Rx output terminal (18), wherein
e) the resonator circuit is a parallel inductance-capacitance-circuit.

2. A wireless communication device for wireless communication applications, comprising an antenna coupled to a high- and low pass filter, a RF signal switch circuit, a RF receiver and a RF transmitter, said RF signal switch being coupled to said high- and low pass filter by an I/O terminal (8), to said receiver by a Rx output terminal (18), and to said transmitter circuit by a Tx input terminal (10), wherein
a) said I/O terminal (8) is arranged for receiving and transmitting a RF signal via said high-and low pass filter from respectively to said antenna
b) said Tx input terminal (10) is coupled to I/O terminal (8) through a diode (12),
c) said Rx output terminal (18) is coupled to I/O terminal (8), and
d) said RF signal switch circuit further comprises a resonator circuit for isolating the Tx input terminal (10) from the Rx output terminal (18) said resonator circuit being a parallel inductance-capacitance circuit comprising an inductor (22) and a capacitor (20).

3. A device as claimed in claim 1, wherein the inductor (22) is coupled between the Tx input terminal (10) and the Rx output terminal (18) and through a diode (24) to ground, and wherein the capacitor (20) is coupled between the I/O terminal (8) and a node (28) between the inductor (22) and ground.

4. A device as claimed in claim 1, wherein the parallel inductance-capacitance-circuit is tunable.

5. A device as claimed in claim 1, wherein the parallel inductance-capacitance-circuit is switchable between pre-selected resonance values.

6. A device as claimed in claim 1, wherein the inductance-capacitance-circuit is dimensioned to provide an impedance of at least 20 times the impedance of the inductor.

7. A device as claimed in claim 1, wherein the components of the circuit are embodied in LTCC technology.

8. A device as claimed in claim 1, wherein the circuit comprises a matched 50 Ohm circuit.

9. A device as claimed in claim 1, wherein the diodes are PIN diodes.
